(19) United States
(12) Patent Application Publication
(10) Pub. No.: US 2025/0270004 A1
(43) Pub. Date: Aug. 28, 2025

(54) PACKAGING AND METHOD OF MANUFACTURING A PACKAGING

(71) Applicant: MULTIVAC MARKING & INSPECTION GMBH & CO. KG, Enger (DE)

(72) Inventors: Michael REFFKE, Rödinghausen (DE); Ronald HELMEL, Seeboden (AT)

(73) Assignee: MULTIVAC MARKING & INSPECTION GMBH & CO. KG, Enger (DE)

(21) Appl. No.: 19/063,946

(22) Filed: Feb. 26, 2025

(30) Foreign Application Priority Data
Feb. 26, 2024 (DE) 102024105269.4

(51) Int. Cl. B65D 25/20

(52) U.S. Cl. CPC B65D 25/205; B65D 2203/02; B65D 2577/2075

(57) ABSTRACT

The disclosure relates to a packaging which comprises a packaging lower part, which is in the form of a packaging tray with a tray edge projecting circumferentially, and a lid part which is adhesively bonded to the tray edge. The lid part comprises a self-adhesive label which is removed from a carrier band and to the underside of which adhesive is applied exclusively circumferentially in the region of a label edge to be adhered to the tray edge. Furthermore, the disclosure relates to a method for producing a packaging.

### CROSS-REFERENCE TO RELATED APPLICATIONS

This application claims foreign priority benefits under 35 U.S.C. § 119 (a)-(d) to German patent application number DE 102024105269.4, filed Feb. 26, 2024, which is incorporated by reference in its entirety.

### TECHNICAL FIELD

The present disclosure relates to a packaging and to a method for producing a packaging.

### BACKGROUND

EP 2666728 B1 discloses a thermoforming packaging machine with a labeler. The labeler is arranged in the production direction downstream of a sealing station of the thermoforming packaging machine and is configured to apply a label to each of the packaging troughs coming from the sealing station and sealed therein with a top film. The respective labels are separated from a carrier layer and affixed to the lid part formed by the top film.

Whereas in EP 2666728 B1 the top film fed to the sealing station serves to close the packaging troughs, the labels applied downstream by the labeler following the tray closing process carried out within the sealing station have the function of providing the sealed packaging with an indication of the product contained therein and therefore have an information function.

The disadvantage of this is that a relatively large amount of packaging material is used for packaging labeled in this way. In addition, a sealing station is required to produce the packaging.

Furthermore, the entire underside of the respective labels, in particular the entire surface, is covered with adhesive so that they can be firmly attached to the top film. Accordingly, to detach the respective labels from a carrier band of a label roll, the carrier band is coated over its entire surface, for example with a thin layer of silicone. As a result, the proportion of the coating material on the carrier band, in particular a silicone proportion of the carrier band, can be relatively high, in particular higher than 10% of the total carrier material, which means that the carrier band remaining after the labeling process can only be recycled at great expense from material proportions that are approximately even in terms of quantity, at least not as a monomaterial.

Furthermore, label rolls are known in practice that do not require a carrier layer, i.e., consist solely of a label band. In specialist circles, such label rolls are called “linerless”. In order to prevent the wound label band from sticking together, it is provided with adhesive on its underside, for example with adhesive strips, and with a corresponding coating on its upper side, for example with silicone strips, so that the adhesive provided on the underside coincides with the coating provided on the upper side in the wound state. In particular, the adhesive strips formed on the underside lie directly on the silicone strips provided along the top side, so that the label roll does not require a separate carrier layer. This allows packaging to be produced with reduced packaging material requirements. However, the disadvantage is that the separation or cutting of labels from such a label roll can only be carried out directly on a labeling machine, and there only by certain means, e.g., by means of a cutting knife installed on it. However, only straight-cut labels can be produced in this way. The fact that these labels cannot be cut in advance means that production times are longer. Another disadvantage is that the packaging produced from these labels comprises labels with a coating on the upper side, in particular traces of silicone.

### SUMMARY

Against the background of the state of the art described above, a problem underlying the disclosure is to provide a stable and sustainable packaging that can be produced at low cost and a corresponding method for producing a packaging.

This problem is solved by means of a packaging according to the disclosure and by means of a method according to the disclosure.

The disclosure relates to a packaging which comprises a packaging lower part, which is in the form of a packaging tray with a tray edge projecting all around, and a lid part which is adhesively bonded to the tray edge. Characteristic of the disclosure is that the lid part consists of a self-adhesive label removed from a carrier band, on the underside of which adhesive is applied exclusively circumferentially in the area of a label edge to be adhered to the tray edge. This creates an all-round adhesion along the tray edge, allowing the self-adhesive label to be reliably fixed to the tray edge as a lid part.

In the disclosure, only the label edge that rests on the tray edge is provided with adhesive all around. An adhesive layer or adhesive track formed from the adhesive can be produced within an overlapping area, in which the label edge and the tray edge lie on top of each other, over the entire surface all around or in a predetermined pattern all around. The adhesive layer can extend over the entire overlap area or only cover part of it.

The adhesive layer or adhesive track formed all around the label edge closes the packaging, preferably without gaps, along all sides of the entire edge area. This means that it is no longer possible to access the packaging via the edge area. Furthermore, there is no possibility of a product contained in the packaging, for example fruit or vegetables, falling out of the packaging.

A limited adhesive track applied to the label edge means that the amount of adhesive present on the self-adhesive label is relatively low. Overall, the proportion of adhesive used for the packaging is therefore relatively low, making it possible to produce sustainable, cost-reduced packaging. In addition, despite the low adhesive content, the adhesive applied all around the label edge, i.e., to all sides, enables sufficiently stable fixation of the self-adhesive label along the tray edge. Packaging produced in this way can therefore be stacked particularly well without the risk of the lid parts formed from self-adhesive labels being dented by stacking.

It is also advantageous that the carrier band providing the self-adhesive labels according to the disclosure has silicone tracks corresponding to the respective adhesive tracks, on which the self-adhesive labels can be stuck for a tray sealing process on a labeler. This means that the silicone content of the carrier band is relatively low, so that the carrier band material remaining after the self-adhesive labels have been removed can in principle be recycled as a monomaterial. In particular, the carrier tape material can have a silicone content of less than 10%, possibly even less than 5% of the total carrier tape material. A carrier band made of paper could therefore be recycled as paper despite the silicone traces on it due to its negligible material content.

Furthermore, the self-adhesive label with partial adhesive according to the disclosure can also be better recycled.

In contrast to linerless applications, the fact that the lid part of the packaging according to the disclosure consists of a self-adhesive label removed from a carrier band makes it possible to produce a lid part without a coating, in particular without traces of silicone, on its upper side. In contrast to linerless applications, it is also possible to produce self-adhesive labels with any label contours or self-adhesive labels in any shape on the carrier band.

According to one embodiment of the disclosure, the adhesive is applied in the form of an endless adhesive track running along the label edge, in the form of an adhesive track composed of adhesive segments, in the form of a dashed adhesive track and/or in the form of a dotted adhesive track. The respective adhesive tracks extend at least along significant areas of all sides of the label edge. This results in reliable all-round adhesion on all sides of the packaging.

It is conceivable that the adhesive is applied over the entire surface or in a predetermined pattern, for example in a striped, dotted, zigzag and/or wavy pattern, within the continuous adhesive track and/or within the adhesive segments.

One variant provides for the adhesive track to form an area of adhesive which corresponds to at least 70%, preferably at least 80%, further preferably at least 90% of an area formed by the tray edge facing the lid part. In particular, the adhesive track substantially coincides with the overlap area formed between the tray edge and the label edge. This secures the lid part very stably to the tray edge.

Preferably, the self-adhesive label is completely separated from a material from which the carrier band is made. In other words, the lid part consists only of the self-adhesive label. This means that the carrier band is present as a complete band after the self-adhesive labels have been removed, i.e., no material cut-out of the carrier band remains on the respective undersides of the removed self-adhesive labels. This means that the material is cleanly separated as soon as the self-adhesive labels are removed from the carrier band.

According to one embodiment of the disclosure, the self-adhesive label comprises at least one tear tab. This is formed outside the label edge used for adhesion and can be used to open the packaging.

It would be expedient if the self-adhesive label comprised at least one tear-open perforation, in particular a tear-open perforation which runs at least in sections along an inner boundary of the adhesive applied to the label edge. The tear-open perforation can be in the form of a punched tear line that runs along the inner boundary of the label edge in such a way that the label edge remains adhesively bonded to the tray edge when the packaging is opened. A section that can be separated from the self-adhesive label along the perforation can be recycled as a mono-material, as the adhesive portion of the self-adhesive label remains on the packaging tray. The adhesive forms a negligible amount of material on it, so that in principle the packaging tray can also be recycled as a mono-material.

In particular, the self-adhesive label can be made from a plastic, especially from a polypropylene (PP) or polyethylene terephthalate (PET) film, or from a paper fiber-based material, especially from a plastic-reinforced, paper fiber-based tape.

According to a preferred variant, an upper side of the self-adhesive label facing away from the product is free of silicone. This results in an optically advantageous top side of the label. Without silicone (traces) on the upper side of the lid part, the packaging produced can also be stacked more easily because there are no unsightly silicone marks on the upper side of the lid part.

The adhesive content of the material from which the self-adhesive labels are made is preferably less than 10% by weight, in particular less than 5%, so that the self-adhesive label can be recycled as plastic or paper.

Preferably, the packaging lower part is a cardboard tray or a plastic tray. Preferably, the material of the packaging lower part corresponds to the material of the lid part, i.e., the material of the self-adhesive label. Overall, this results in sustainably produced packaging that is particularly easy to recycle.

According to one embodiment, the self-adhesive label is designed with several holes. In particular, the holes are distributed in such a way that they create windows through which the products contained in the packaging can be viewed from the outside. The holes also ensure that the packaging is well ventilated so that no condensation forms inside the packaging.

It would be conceivable for the self-adhesive label to be transparent. The self-adhesive label is thus provided as a window outside the label edge, i.e., above the product packaged underneath, which makes it easy for the consumer to inspect the contents of the packaging.

It is conceivable that the self-adhesive label is printed with a motif on its upper side, for example with a motif that depicts the packaged product. The motif is available in particular as a readable information carrier. In particular, the motif may be a code containing information relating to the packaged product, e.g., a barcode.

According to one embodiment of the disclosure, the self-adhesive label comprises a detectable marking on its upper side for a controlled tray sealing process. Such a marking can be detected by means of a sensor device, whereby a measurement obtained in this way can be used for the purpose of precise application of the self-adhesive label to the tray edge of the packaging tray.

One variant provides for the tray edge and the adhesive track to be essentially in the shape of a square, a rectangle or a round or oval ring. In particular, a square shape with rounded corners or a rectangular shape with rounded corners could be considered.

The disclosure also relates to a method for producing a packaging which is made from a packaging lower part, which is in the form of a packaging tray with a tray edge projecting circumferentially, and from a lid part adhesively bonded to the tray edge. The method according to the disclosure provides that, to form the lid part, a self-adhesive label, on the underside of which adhesive is applied exclusively circumferentially in the area of a label edge to be adhered to the tray edge, is separated from a carrier band of a label roll provided and adhesively bonded to the tray edge of the packaging tray as the lid part. This creates a reliable all-round bond along the tray edge.

In addition, relatively little adhesive is required overall to produce the packaging, as adhesive is only applied along the label edge facing the tray edge, while the surface of the self-adhesive label facing the product is free of adhesive. In addition, the carrier band material can accordingly be produced with a very low silicone content overall, in particular with a silicone content of less than 5% of the total carrier band material, because silicone areas on the surface of the carrier band can be reduced in terms of area in adaptation to the adhesive applied partially to the underside of the self-adhesive label, i.e., only in the area of the label edge.

In addition, the self-adhesive labels provided on the carrier band, which are themselves used as lid parts according to the disclosure, can be produced in any label shapes or with any label contours, and are characterized in particular by a silicone-free top side. The fact that separating the self-adhesive labels from the carrier band leaves the latter as a complete band results in a clean material separation between the self-adhesive label material and the carrier band material. This also means that prefabrication of the carrier band requires little effort.

One variant provides that when the self-adhesive label is separated from the carrier band, an adhesive track formed from adhesive on the underside of the self-adhesive label is separated from a corresponding silicone track formed on the carrier band. This means that only a small amount of silicone is required on the carrier band. It is conceivable that the silicone content on the carrier band is less than 5% of the total carrier band material, which makes the carrier band material easier to recycle. In particular, a carrier band made of paper can be recycled as paper with a silicone content of less than 5%.

In particular, to produce the label roll for the respective self-adhesive labels, the adhesive is applied to a label layer in the form of a continuous adhesive track running along the respective label edge, in the form of an adhesive track composed of adhesive segments running along the respective label edge, in the form of a striped adhesive track running along the respective label edge and/or in the form of a dotted adhesive track running along the respective label edge. Within the continuous adhesive track and/or within the respective adhesive segments, the adhesive can be applied over the entire surface or in a predetermined pattern.

Preferably, by separating the self-adhesive label from the carrier band, the self-adhesive label is completely separated from a material from which the carrier band is made. This means that when the self-adhesive label is removed from the carrier band, no sections of the carrier band remain attached to the underside of the self-adhesive label, but the carrier band remains as a complete band. The lid part thus consists only of the material of the self-adhesive label, which results in sustainable packaging with reduced material and weight.

In particular, it can be provided that by separating all self-adhesive labels from the carrier band of the label roll, a carrier band material with a silicone content of less than 10%, preferably less than 7%, more preferably less than 5% remains. Such a residual carrier tape material could be easily shredded, in particular at the place where the packaging is produced, for example by means of a knife device associated with the labeler, in order to be more suitable for logistical purposes in shredded form.

According to an advantageous process step, holes are punched in the self-adhesive labels. The holes can be made in a format of 3×4, 4×4 or 5×5, for example, so that the finished packaging is well ventilated and the contents of the packaging are easier to see.

A process step according to which at least one tear-open perforation is punched into the self-adhesive labels would be useful. Preferably, the perforation is produced in the form of a tear line running directly next to an internal boundary of the adhesive track. This would allow an internal section of the self-adhesive label without adhesive to be torn out along the tear line to open the packaging in such a way that the label edge with the adhesive track remains stuck to the tray edge of the packaging tray.

It is conceivable that at least one detectable marking for a controlled tray closing process could be produced on the carrier band and/or on the self-adhesive labels attached to it.

The fact that the adhesive on the packaging according to the disclosure is limited to the overlap area formed between the label edge and the tray edge, i.e., an area occupied by adhesive is at most as large as the overlap area, and accordingly the method according to the disclosure can produce packaging with lid parts from self-adhesive labels with a reduced adhesive content, results in an increased savings potential, since relatively little adhesive is used overall and, furthermore, a reduced silicone content on the carrier band is possible. Nevertheless, very stable packaging can be produced that is easy to stack for logistical purposes.

This cost-saving potential is also accompanied by an advantageous recyclability of the materials used, as there is a negligible amount of adhesive or silicone in the material of the packaging or in the material of the remaining carrier band. In addition, the disclosure offers advantages in the production of label shapes comprising contours as well as visual advantages of the lid parts produced from self-adhesive labels without silicone traces.

It is conceivable that a label roll used for the packaging according to the disclosure or for the method according to the disclosure for producing packaging according to the disclosure is produced as follows:
Providing a web of material with a carrier layer and a label layer, the label layer being bonded to the carrier layer by means of adhesive,
punching or lasering the label layer in order to define self-adhesive labels on the carrier layer with a shape predetermined in accordance with the punching or lasering, so that the self-adhesive labels are provided with adhesive circumferentially on their undersides exclusively in the area of a label edge to be adhered to a tray edge,
peeling off the die-cut grid formed by die-cutting or lasering the label layer so that individual self-adhesive labels with the predetermined shape remain adhered to the carrier layer,
winding up the web of material prefabricated by die-cutting or lasering to form a label roll with self-adhesive labels.

### BRIEF DESCRIPTION OF THE DRAWINGS

Embodiments according to the disclosure are explained in more detail with reference to the following figures:

FIG. 1 is a perspective view of a packaging with a lid part designed as a self-adhesive label;

FIG. 2 is a sectional A-A view of the packaging shown in FIG. 1;

FIG. 3A is an isolated view of a lid part in the form of a self-adhesive label;

FIG. 3B is an isolated view of a further lid part in the form of a self-adhesive label;

FIG. 3C is an isolated illustration of a further lid part designed as a self-adhesive label;

FIG. 4 shows a label roll with self-adhesive labels on a carrier band;

FIG. 5 shows a label roll with self-adhesive labels on a carrier band;

FIG. 6 is an isolated view of a carrier band; and

FIG. 7 shows a labeler for closing tray parts provided with lid parts.

Identical components are given the same reference signs throughout the figures.

### DETAILED DESCRIPTION

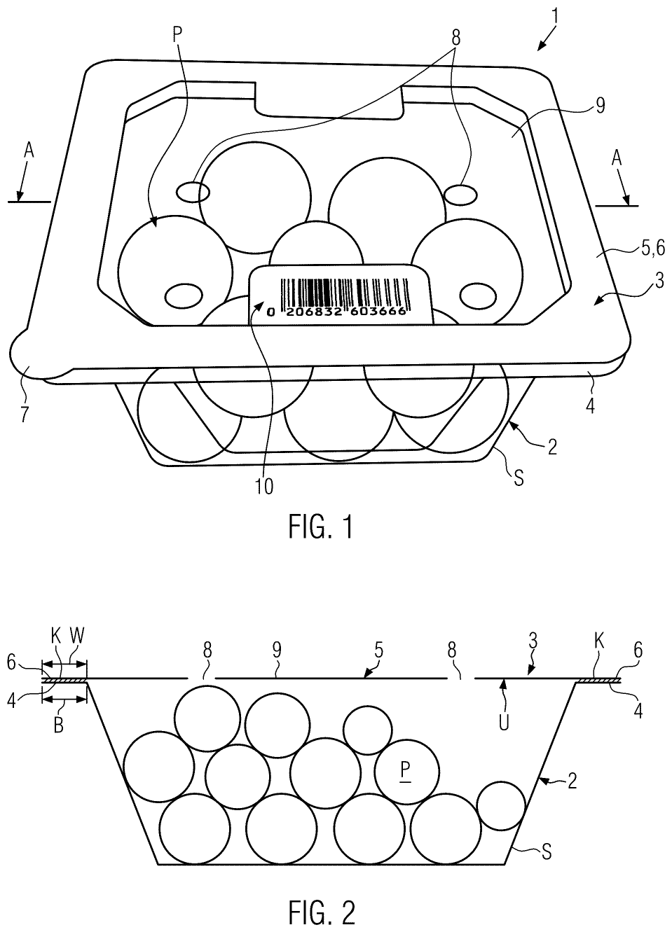

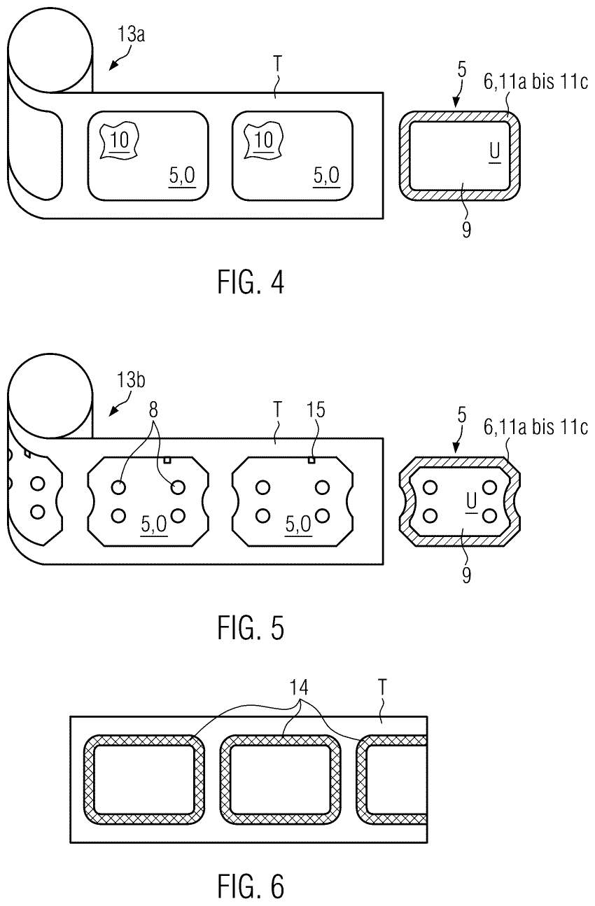

FIG. 1 shows a finished packaging 1. The packaging 1 comprises a packaging lower part 2 and a lid part 3, which is adhesively bonded to a tray edge 4 of the packaging lower part 2. The packaging lower part 2 of the packaging 1 is in the form of a packaging tray S, which is filled with a product P, in this case tomatoes. The lid part 3 consists of a self-adhesive label 5 removed from a carrier band T (see FIGS. 4 and 5). The self-adhesive label 5 forms a label edge 6, which is provided with adhesive K (see FIG. 2) in order to adhere the lid part 3 in the area of the label edge 6, which rests on the tray edge 4, to the tray edge 4 of the packaging lower part 2.

According to FIG. 1, the self-adhesive label 5 comprises a tear tab 7 protruding from the label edge 6. FIG. 1 also shows ventilation holes 8, which ensure air circulation. A readable motif 10 in the form of a barcode is provided on the lid part 3.

According to FIG. 1, an inner area 9 of the self-adhesive label 5 surrounded by the label edge 6 is transparent. This creates a window so that the products P held in the packaging tray S can be seen through the lid part 3.

FIG. 2 shows the packaging 1 of FIG. 1 in section A-A. FIG. 2 shows that the self-adhesive label 5 comprises adhesive K on its underside U only in the area of the label edge 6 in order to be attached to the tray edge 4. On the other hand, there is no adhesive K on the underside U of the inner area 9 and no additional separating or protective layer attached to the underside U of the self-adhesive label 5 by means of adhesive K. Rather, the self-adhesive label 5 of FIG. 2 has a single-layer structure in the inner area 9 without comprising adhesive K on its underside U.

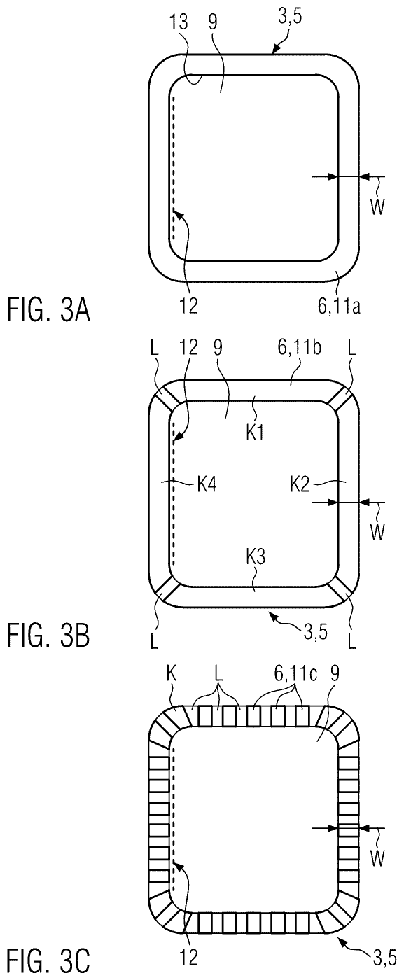

FIGS. 3A to 3C show self-adhesive labels 5 with different types of adhesive traces 11a to 11c.

FIG. 3A shows the lid part 3 in an isolated, schematic top view. The lid part 3, designed as a self-adhesive label 5, comprises adhesive K in the area of the label edge 6 to be adhered to the tray edge 4 in the form of an endless adhesive track 11a running all around the tray edge 4 of the packaging tray S and provided with adhesive K over the entire surface. The adhesive track 11a comprises a track width W, which is 1 cm, for example. The track width W of the adhesive track 11a can correspond to a width B of the tray edge 4 (see FIG. 2) or be slightly narrower or wider than this.

Furthermore, a tear-open perforation 12 for opening the packaging 1 is shown in FIG. 3A. The tear-open perforation 12 can be in the form of a punched line and allows the inner area 9 to be easily pressed in. In FIG. 3A, the tear-open perforation 12 is formed in sections along an inner boundary 13 of the adhesive track 11a. However, the tear-open perforation 12 can also be formed along the entire inner boundary 13. This would allow the inner area 9 to be easily separated from the label edge 6 in order to open the packaging 1. The inner area 9 can then be recycled as a mono-material without adhesive content. The label edge 6 with adhesive K that sticks to the packaging tray S forms a very small proportion by weight of the packaging tray S, so that the packaging tray S can also be disposed of as a high-percentage monomaterial.

It would be possible for the tear-open perforation 12 to be formed along the inner boundary 13 in such a way that separating the tear-open perforation 12 results in a flap from the inner area 9 or a section of the inner area 9. This flap can be used to open or close the packaging. As a result, the label edge 6 provided with adhesive K and the tray edge 4 remain isolated, so that the products P cannot come into contact with the adhesive K.

FIG. 3B shows an adhesive track 11b running all around the label edge 6, which is made up of adhesive segments K1 to K4 on all sides. According to FIG. 3B, adhesive K is applied over the entire surface within the respective adhesive segments K1 to K4. In corner areas of the label edge 6, gaps L are provided between the adhesive segments K1 to K4, in which no adhesive K is applied. Despite these adhesive-free areas, the adhesive segments K1 to K4 provided on all sides ensure reliable all-round adhesion.

FIG. 3C shows an adhesive track 11c running all the way around the label edge 6, within which gaps L alternate with adhesive strips of adhesive K. This striped adhesive track 11c also creates a reliable all-round bond, which allows the lid part 3 to be stably attached to the packaging lower part 2.

FIG. 4 shows a label roll 13a. The label roll 13a comprises a carrier band T and self-adhesive labels 5 glued to it. The self-adhesive labels 5 of the label roll 13a are adhesively bonded to the carrier band T by means of the adhesive track 11a to 11c of adhesive K formed on its underside U along silicone tracks 14 produced accordingly on the carrier band T (see FIG. 6). The silicone tracks 14 are thus also formed all around. Thus, the adhesive tracks 11a to 11c made of adhesive K produced on the underside U of the self-adhesive labels 5 coincide with the silicone tracks 14 made of a silicone produced along the carrier band T. Along the inner area 9, the self-adhesive labels 5 are not adhesively bonded to the carrier band T, but lie unconnected on the carrier band T in this area 9. A motif 10, for example a barcode, is provided on an upper side O of the self-adhesive labels 5.

FIG. 4 also shows a self-adhesive label 5 separated from the carrier band T with the adhesive track 11a to 11c of adhesive K formed on its underside U.

FIG. 5 shows another label roll 13b. The self-adhesive labels 5 adhesively bonded to the carrier band T in FIG. 5 comprise a different geometry compared to the self-adhesive labels 5 shown in FIG. 4. These self-adhesive labels 5 are also adhesively bonded to the carrier band T along silicone tracks 14 made of silicone produced all around it by means of the adhesive tracks 11 made of adhesive K produced accordingly on their underside U. The self-adhesive labels 5 of FIG. 5 optionally comprise a marking 15 on their upper side O that can be detected by a sensor for a controlled tray closing process.

FIG. 5 also shows a self-adhesive label 5 separated from the carrier band T with an adhesive track 11a to 11c of adhesive K formed on its underside U.

The respective self-adhesive labels 5, which are adhesively bonded to the respective carrier band T as shown in FIGS. 4 and 5, may comprise any prefabricated label shapes, in particular may form a desired lid geometry with respect to the geometry of the packaging tray S to be dispensed therewith.

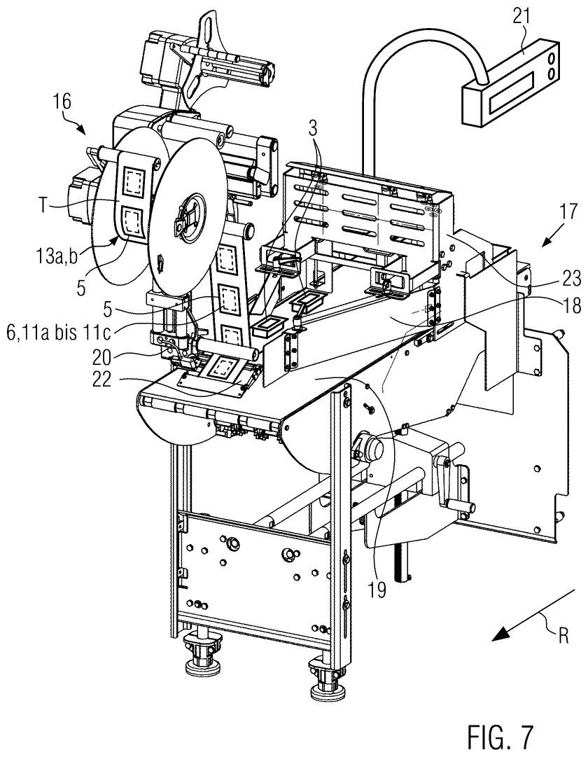

FIG. 6 shows the carrier band T in isolated representation, i.e., without self-adhesive labels 5 adhesively bonded thereto. It can be seen that the silicone tracks 14 produced on the carrier band T are produced at a distance from one another. A label layer (not shown) with correspondingly formed adhesive tracks 11a to 11c can be attached along the silicone tracks 14 during the production of the self-adhesive labels 5. This label layer can then be cut to size by die-cutting or laser cutting in order to produce self-adhesive labels 5 with a desired self-adhesive label shape on the carrier layer T. The die-cut grid formed along the label layer is removed so that only individual self-adhesive labels 5, for example in the form of the self-adhesive labels 5 shown in FIG. 4 and/or FIG. 5, remain adhered to the carrier layer T after die-cutting or lasering. Subsequently, the now prefabricated material web is wound up from the carrier web T and the self-adhesive labels 5 cut to size on it in order to be used as a label roll 13a, 13b on a labeler 16 (see FIG. 7).

FIG. 6 shows that the silicone content on the carrier band T produced by the silicone traces 14 is only a small proportion of the total carrier band material, and in particular can be less than 5% of the total carrier band material. This means, for example, that a carrier band T made of paper can be recycled as paper despite the silicone traces 14 produced on it.

FIG. 7 shows a labeler 16 with a feeding device 17, which according to FIG. 7 is in the form of a line unifier. By means of the feeding device 17, packaging lower parts 2 loaded with product P, which are not yet provided with a lid part 3, are fed to the labeler 16. Two guide rails 18 are positioned converging towards each other in such a way that a gap or opening for packaging lower parts 2 is created at the end of the guide rails 18 located downstream in the production direction R, which is only slightly wider than the width of the packaging lower parts 2 themselves.

This allows the packaging lower parts 2 transported on the feeding device 17 by means of a conveyor belt 19 running thereon to be fed precisely to the labeler 16. This in turn makes it possible for a self-adhesive label 5 from the label roll 13a, 13b to be adhesively bonded precisely to a supplied packaging lower part 2 after being pulled off the carrier band T in order to close the packaging lower part 2.

A sensor 20, which is provided on the labeler 16, can detect a front edge of a packaging lower part 2 to be labeled and closed while the packaging lower part 2 is being transported along the guide rails 18. The sensor 20 can be designed as a light barrier or proximity sensor and is connected to a control unit 21 and transmits the signal, namely the detection of the front edge of the lower packaging part 2, to the latter. The controller 21 controls the movement of the self-adhesive label 6 to be dispensed by means of the speed and path of the label roll 13a, 13b attached to the labeler 16 towards and along a dispensing edge 22 in order to detach the self-adhesive label 5 from the carrier band T and apply it to the lower packaging part 2.

Preferably, the speed of the label roll 13a, 13b during the dispensing process onto the packaging lower part 2 is identical to the speed of the conveyor belt 19.

Upstream of the labeler 16, a stopper device 23 is arranged on the feeder 17 in front of the guide rails 18 in order to stop the packaging lower parts 2 while the conveyor belt 19 is running. Stopped lower packaging parts 2 can thus be released piece by piece for the labeling process, i.e., for the tray closing process at the labeler 16.

What is claimed is:

1. A packaging comprising a lower packaging part, which is in a form of a packaging tray with a tray edge projecting all around, and a lid part, which is adhesively bonded to the tray edge, wherein the lid part comprises a self-adhesive label which is removed from a carrier band and to its underside adhesive is applied circumferentially exclusively in a region of a label edge to be adhered to the tray edge.

2. The packaging according to claim 1, wherein the adhesive is present in a form of an endless adhesive track running along the label edge, in a form of an adhesive track composed of adhesive segments, in a form of a striped adhesive track and/or in a form of a dotted adhesive track.

3. The packaging according to claim 2, wherein the adhesive track forms an area of adhesive which corresponds to at least 70% of an area formed by the tray edge and facing the lid part.

4. The packaging according to claim 2, wherein the adhesive track forms an area of adhesive which corresponds to at least 80% of an area formed by the tray edge and facing the lid part.

5. The packaging according to claim 2, wherein the adhesive track forms an area of adhesive which corresponds to at least 90% of an area formed by the tray edge and facing the lid part.

6. The packaging according to claim 1, wherein the self-adhesive label is completely separated from a material from which the carrier band is made.

7. The packaging according to claim 1, wherein the self-adhesive label comprises at least one tear tab and/or at least one tear perforation.

8. The packaging according to claim 1, wherein the self-adhesive label comprises a tear perforation which extends at least in sections along an inner boundary of the adhesive.

9. The packaging according to claim 1, wherein the self-adhesive label is made of a plastic or of a paper fibre-based material.

10. The packaging according to claim 1, wherein the self-adhesive label is made of polypropylene or polyethylene terephthalate.

11. The packaging according to claim 1, wherein the self-adhesive label is made of a plastic-reinforced, paper fibre-based material.

12. The packaging according to claim 1, wherein an upper side of the self-adhesive label is free of silicone.

13. The packaging according to claim 1, wherein the lower packaging part is a cardboard tray or a plastic tray.

14. The packaging according to claim 1, wherein the self-adhesive label is formed with a plurality of holes.

15. A method for producing a packaging from a packaging lower part, which is in a form of a packaging tray with a tray edge projecting circumferentially, and from a lid part, the method comprising:
separating a self-adhesive label, to whose underside adhesive is exclusively applied circumferentially in a region of a label edge to be adhered to the tray edge, from a carrier band of a provided label roll; and
adhesively bonding the self-adhesive label as the lid part to the tray edge of the packaging tray.

16. The method according to claim 15, wherein, when the self-adhesive label is separated from the carrier band, an adhesive track formed from adhesive on the underside of the self-adhesive label is separated from a silicone track formed accordingly on the carrier band.

17. The method according to claim 15, wherein, in order to produce the label roll for the self-adhesive label, the adhesive is applied to a label layer in a form of an endless adhesive track running along the label edge, in a form of an adhesive track extending along the label edge and comprising adhesive segments, in a form of a striped adhesive track extending along the label edge and/or in a form of a dotted adhesive track extending along the label edge.

18. The method according to claim 15, wherein by separating the self-adhesive label from the carrier band, the self-adhesive label is completely separated from a material from which the carrier band is made.

19. The method according to claim 15, wherein the label roll initially comprises the self-adhesive label and multiple additional self-adhesive labels on the carrier band, and by separating all the self-adhesive labels from the carrier band of the label roll, a carrier band material with a silicone content of less than 10% remains.

20. The method according to claim 15, wherein holes and/or at least one tear-open perforation are punched into the self-adhesive label.
